(19) United States
(12) Patent Application Publication
(10) Pub. No.: US 2020/0150575 A1
(43) Pub. Date: May 14, 2020

(54) IMAGE FORMING DEVICE, IMAGE FORMING METHOD AND NON-TRANSITORY RECORDING MEDIUM

(71) Applicant: Konica Minolta, Inc., Tokyo (JP)

(72) Inventor: Hideo YAMAKI, Tokyo (JP)

(21) Appl. No.: 16/667,728

(22) Filed: Oct. 29, 2019

(30) Foreign Application Priority Data
Nov. 12, 2018 (JP) 2018-211900

(51) Int. Cl. G03G 15/00

(52) U.S. Cl. CPC G03G 15/5033

(57) ABSTRACT

An image forming device provided with a wear part arranged in a manner being in contact with a surface of an image carrier to wear the surface of the image carrier, comprises: a hardware processor that: detects a film thickness of the image carrier; detects a deterioration progress degree of the image carrier; and compares the detected film thickness with the detected deterioration progress degree, and adjusts a wear amount of wear due to the wear mean based on the comparison result.

Japanese patent application No. 2018-211900 filed on Nov. 12, 2018 including description, claims, drawings, and abstract the entire disclosure is incorporated herein by reference in its entirety.

### BACKGROUND

### Technological Field

The present invention relates to an electrophotographic image forming device, an image forming method and a non-transitory recording medium.

### Description of the Related Art

Electrophotographic image forming devices such as printers and MFPs (Multifunction Peripherals) electrify and expose on a photosensitive layer which is provided as an image carrier on a surface of a photoreceptor drum and form an electrostatic latent image. The image forming devices supply toner to the electrostatic latent image to attach the toner to the electrostatic latent image, and develop the electrostatic latent image as a toner image. The image forming devices transfer the toner image on a sheet type recording material so that an image is formed on the recording material. This type of the image forming devices that repeatedly form images deteriorate the surface of the photosensitive layer due to repeatedly performed electrification and discharge. This deterioration of the photosensitive layer is one of causes that lead an image quality deterioration.

A cleaning blade and an intermediate transfer belt are in contact with the surface of the photoreceptor drum. Upon repeatedly forming images, the photosensitive layer deteriorates and a film thickness is gradually reduced. Once the film thickness of the photosensitive layer is reduced less than a predetermined value, a life of the photoreceptor drum expires.

Various types of techniques to detect the film thickness of the photosensitive layer applied to the above-described image forming device have been proposed. This known technique is introduced for example in Japanese Patent Applications Laid-Open No. JP 2014-6561 A (hereafter, document D1), JP 2015-148789 A (hereafter, document D2) and JP 2014-149338 A (hereafter, document D3). According to the document 1, an image forming device that detects a film thickness of a photosensitive layer with DC voltage and sets a reduced alternating testing current as the film thickness of the photosensitive layer is reduced is recited. The document D2 recites an image forming device that corrects a film thickness based on environmental data upon detecting the film thickness of a photosensitive layer based on a V-I characteristic, and detects the accurate thickness of the photoreceptor so that an electrification voltage corresponding to the film thickness is applied. The document D3 recites an image forming device that estimates a film thickness based on a speed value showing a speed of reducing the film thickness and compares the estimated value with the film thickness actually measured so that correcting the speed value to be used for next estimation based on the comparison result.

As described above, the deterioration in the surface of the photosensitive layer causes the image quality deterioration in forming the images. If the deteriorated part on the surface of the photosensitive layer can be removed by a part such as the cleaning blade, the image quality deterioration may be controlled. An amount removed by the part such as the cleaning blade (wear amount) is more than the deteriorated part, the image quality deterioration may be controlled but at the same time, the life of the photoreceptor drum becomes shorter. On the other hand, less wear amount remains the deteriorated part on the surface of the photosensitive layer, resulting in the image quality deterioration. If only the deteriorated part on the surface of the photosensitive layer may be removed with the cleaning blade, for instance, two problems of the image quality deterioration and shortened life of the photoreceptor drum may be resolved.

According to the above-described known techniques described in the documents D1 to D3, all of the techniques enable detection of the film thickness of the photosensitive layer but do not enable to control the wear amount of the film thickness in accordance with a rate of wear on the photosensitive layer. The known techniques do not resolve the aforementioned two problems of the image quality deterioration and shortened life of the photoreceptor drum.

### SUMMARY

The present invention is intended to solve the above problems. Thus, the present invention is intended to provide an image forming device, an image forming method and a non-transitory recording medium that control an image quality deterioration and prevent a shortened life of a photoreceptor drum.

First, the present invention is directed to an image forming device provided with a wear part arranged in a manner being in contact with a surface of an image carrier to wear the surface of the image carrier.

To achieve at least one of the abovementioned objects, according to an aspect of the present invention, the image forming device reflecting one aspect of the present invention comprises: a hardware processor that: detects a film thickness of the image carrier; detects a deterioration progress degree of the image carrier; and compares the detected film thickness with the detected deterioration progress degree, and adjusts a wear amount of wear due to the wear mean based on the comparison result.

Second, the present invention is directed to an image forming method applied to an image forming device that comprises a wear part arranged in a manner being in contact with a surface of an image carrier to wear the surface of the image carrier.

To achieve at least one of the abovementioned objects, according to an aspect of the present invention, the image forming method reflecting one aspect of the present invention comprises: detecting a film thickness of the image carrier; detecting a deterioration progress degree of the image carrier; determining an adjustment amount of a wear amount of wear due to the wear part using the detected film thickness and the detected deterioration progress degree; and adjusting the wear amount of wear due to the wear part based on a result of the determination.

Third, the present invention is directed to a non-transitory recording medium storing a computer readable program to be executed by a hardware processor in an image forming device comprises a wear part arranged in a manner being in contact with a surface of an image carrier to wear the surface of the image carrier.

To achieve at least one of the abovementioned objects, according to an aspect of the present invention, the non-transitory recording medium storing a computer readable program to be executed by the hardware processor in the image forming device reflecting one aspect of the present invention causing the hardware processor to perform: detecting a film thickness of the image carrier; detecting a deterioration progress degree of the image carrier; determining an adjustment amount of a wear amount of wear due to the wear part using the detected film thickness and the detected deterioration progress degree; and adjusting the wear amount of wear due to the wear part based on a result of the determination.

### BRIEF DESCRIPTION OF THE DRAWING

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an exemplary conceptual configuration of an image forming device;

FIG. 2 illustrates an exemplary structure of an image forming unit;

FIG. 3 illustrates a block diagram showing an example of a hardware structure of a controller;

FIG. 4 illustrates an example of history information;

FIG. 5 illustrates a relation between a current value and a film thickness;

FIG. 6 illustrates an example of deterioration reference information;

FIG. 7 illustrates an example of a relation between an adjustment amount of an electrification voltage and a coefficient of wear;

FIG. 8 illustrates an example of an adjustment of a deterioration progress degree and a wear progress degree by a wear controller;

FIG. 9 illustrates an example of a relation between a travel distance and the film thickness in accordance with a BW ratio;

FIG. 10 illustrates an example of a relation between the travel distance and the film thickness in accordance with a torque;

FIG. 11 illustrates a relation between a difference in speed between a photoreceptor drum and a brush and the wear coefficient;

FIG. 12 illustrates a relation between a difference in speed between the brush and a flicker and the wear coefficient;

FIG. 13 illustrates a relation between a pressure adjustment value of a cleaning blade and the wear coefficient;

FIG. 14 illustrates a relation between a toner amount of a toner patch and the wear coefficient;

FIG. 15 illustrates a relation between a speed ratio of an intermediate transfer belt and the photoreceptor drum and the wear coefficient;

FIG. 16 illustrates a flow diagram explaining an exemplary procedure of a job controlling process performed when a print job is processed at the image forming device;

FIG. 17 illustrates a flow diagram explaining an exemplary procedure of a wear controlling process performed to adjust the wear progress degree in the image forming device; and

FIG. 18 illustrates a flow diagram explaining an exemplary procedure of a wear amount adjustment in detail.

### DETAILED DESCRIPTION OF EMBODIMENTS

Hereinafter, one or more embodiments of the present invention will be described with reference to the drawings. However, the scope of the invention is not limited to the disclosed embodiments.

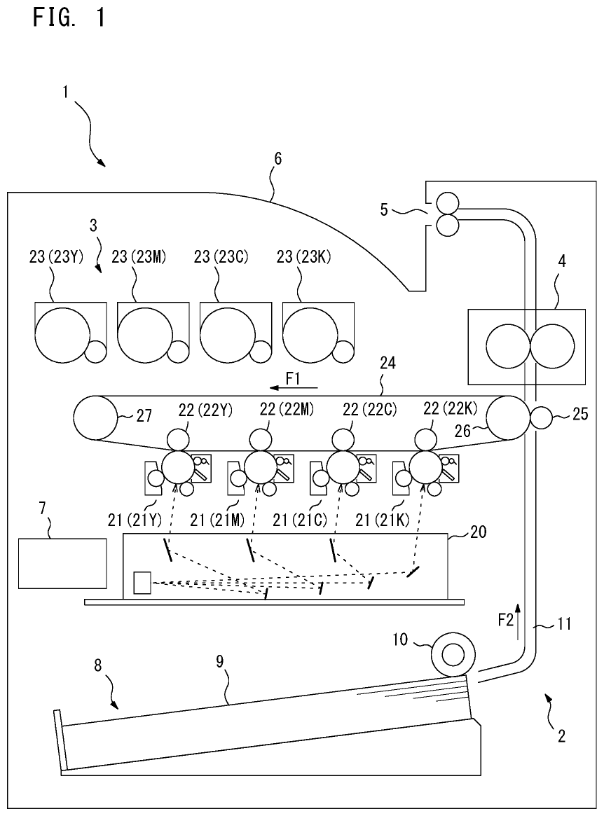

FIG. 1 illustrates an exemplary conceptual configuration of an image forming device 1 in which the present preferred embodiment of the present invention may be practiced. The image forming device 1 of FIG. 1 is a printer capable of forming images on a sheet type recording material 9 in electrophotography and forming color images in tandem system. The image forming device 1 includes a paper feeding unit 2, an image forming unit 3 and a fixing unit 4 inside a device body. The image forming device 1 feeds the sheet type recording material 9 such as a print paper stored in a paper feeding cassette 8 arranged in a lower part one by one and forms a color image or a black and white image on the recording material 9. The image forming device 1 then delivers the recording material 9 on a paper delivery tray 6 from a paper delivery port 5 provided in an upper part. The image forming device 1 includes a controller 7 inside the device body. The controller 7 controls operations of each part such as the paper feeding unit 2, the image forming unit 3 and the fixing unit 4.

The paper feeding unit 2 includes the paper feeding cassette 8, a pick up roller 10, a carrying path 11 and a secondary transfer roller 25. The paper feeding cassette 8 is a container in which a bundle of the sheet type recording materials 9 such as the print papers are stored. The pick-up roller 10 takes the single recording material 9 from a top of the bundle of the recording materials 9 stored in the paper feeding tray 8, and feeds out toward the carrying path 11. The carrying path 11 is a path to carry the recording material 9 in an arrow F2 direction. The recording material 9 is carried along the carrying path 11 so that a toner image is transferred on the recording material 9 when it passes through a nip position of the secondary transfer roller 25. The toner image transferred on a surface of the paper is then fixed to the recording material 9 when the recording material 9 passes through the fixing unit 4. The fixing unit 4 performs a heating operation and a pressure operation on the fed recording material 9 so that the toner image is fixed to the recording material 9. The recording material 9 is then delivered on the paper delivery tray 6 from the delivery port 5.

The image forming unit 3 forms toner images of four colors, Y (yellow), M (magenta), C (cyan) and K (black), and transfers the toner images of the four colors at the same time to the recording material 9 passing through the position of the secondary transfer roller 25. The image forming unit 3 includes an exposure unit 20, image forming units 21 (21Y, 21M, 21C and 21K), primary transfer rollers 22 (22Y, 22M, 22C and 22K), an intermediate transfer belt 24 and toner bottles 23 (23Y, 23M, 23C and 23K) of the respective colors. The image forming units 21 (21Y, 21M, 21C and 21K) are provided for the toners of respective colors. The primary transfer rollers 22 (22Y, 22M, 22C and 22K) are provided corresponding to the respective image forming units 21. Four image forming units 21Y, 21M, 21C and 21K, for example, are provided in a lower position of the intermediate transfer belt 24. The exposure unit 20 is arranged in a further lower position of the four image forming units 21Y, 21M, 21C and 21K. Each of the toner bottles 23Y, 23M, 23C and 23K supplies the toner of each color to the corresponding image forming unit 21Y, 21M, 21C or 21K.

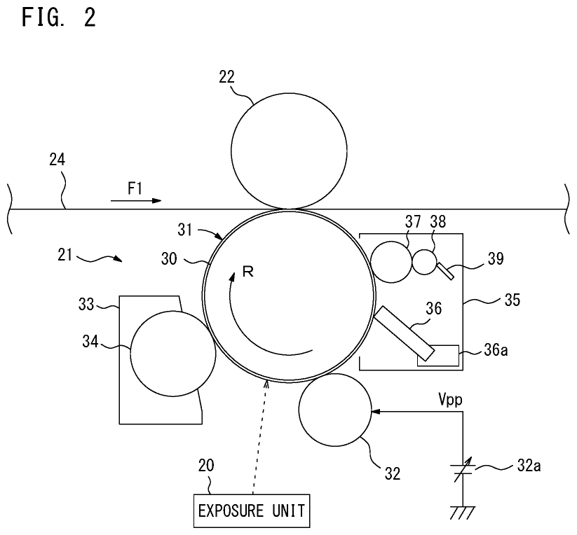

FIG. 2 illustrates an exemplary structure of the image forming unit 21. The four image forming units 21Y, 21M, 21C and 21K are collectively shown as the image forming unit 21 as an example of FIG. 2. This is the same to the primary transfer roller 22.

As illustrated in FIG. 2, the image forming unit 21 includes a photoreceptor drum 30. A photosensitive layer 31 which is an image carrier is provided with a surface of the photoreceptor drum 30. The photoreceptor drum 30 is driven to rotate in R direction in forming an image. Around the photoreceptor drum 30, an electrifying roller 32, a developing unit 33, the intermediate transfer belt 24, the primary transfer roller 22 and a cleaner 35 are arranged toward R direction in this order.

The electrifying roller 32 is in contact with the surface of the photoreceptor drum 30. The electrifying roller 32 applies an electrification voltage Vpp which is controlled by an electrifying part 32a to the photoreceptor drum 30 so that the surface of the photosensitive layer 31 is electrically charged corresponding to the electrification voltage Vpp.

The exposure unit 20 exposes the photosensitive layer 31 electrified by the electrifying roller 32 with a light such as a laser light or a LED light and rewrites an electrical potential level of the exposed part to an electrical potential level different from an electrical potential level of a part not being exposed. The electrostatic latent image is then formed on the surface of the photosensitive layer 31.

The developing unit 33 includes a developing roller 34 which is arranged in a manner being in contact with or near the surface of the photoreceptor drum 30. The developing unit 33 stirs the toner particles supplied from the toner bottle 23 and supplies the toner to the developing roller 34. The developing roller 34 supplies the toner to the surface of the photoreceptor drum 30 so that it enables toner to be attached to the electrostatic latent images formed by the exposure unit 20. As a result, the electrostatic latent image is made visible with toner, and the toner image is formed on the surface of the photoreceptor drum 30.

The photoreceptor drum 30 on which the toner image is formed is in contact with the intermediate transfer belt 24 at a position facing the primary transfer roller 22 (primary transfer position). The photoreceptor drum 30 then primarily transfers the toner image to the intermediate belt 24. The primary transfer roller 22 may be in contact with the photoreceptor drum 30 and/or separated from the photoreceptor drum 30. When the toner image is formed by the photoreceptor drum 30 which is arranged oppositely to the primary transfer roller 22 in forming the image, the primary transfer roller 22 is driven toward the photoreceptor drum 30 and enables the intermediate transfer belt 24 to be in contact with the surface of the photoreceptor drum 30. A primary transfer voltage is applied to the primary transfer roller 22, and the toner image on the surface of the photoreceptor drum 30 is effectively transferred to the intermediate transfer belt 24. When the multiple number of the recording materials 9 are continuously fed in forming images, the aforementioned primary transfer voltage is turned off for an interval period (paper gap) which is between the toner image to be transferred to the previous recording material 9 and the toner image to be transferred to the following recording material 9. The tonner attached on the surface of the photoreceptor drum 30 is, therefore, not transferred to the intermediate transfer belt 24. When the image is not formed by the photoreceptor drum 30 arranged oppositely in forming the image, the primary transfer roller 22 is driven separately from the photoreceptor drum 30 and is positioned separately so that the primary transfer roller 22 does not get in contact with the surface of the photoreceptor drum 30.

Even after passing through the primary transfer position, toner still remains on the surface of the photoreceptor drum 30. In order to remove the remaining toner, the cleaner 35 is arranged downstream of the primary transfer position. The cleaner 35 includes a cleaning blade 36, a supporting member 36a, a brush 37, a flicker 38 and a scraper 39. The supporting member 36a supports the cleaning blade 36.

The cleaning blade 36 is in contact with the surface of the photoreceptor drum 30 along a width direction of the photoreceptor drum 30 (a vertical direction to the paper surface in the example of FIG. 2). The cleaning blade 36 is a cleaning part that scraps and removes the remaining toner from the surface of the photoreceptor drum 30. The cleaning blade 36 is supported by the supporting member 36a. A press pressure applied by the cleaning blade 36 to the photoreceptor drum 30 is adjusted by the supporting member 36a.

The remaining toner works as one type of abrasive so that a surface layer of the photosensitive layer 31 is also scrapped when the cleaning blade 36 scraps the remaining toner. The cleaning blade 36 is one of wear means that cause wear on the surface of the photosensitive layer 31. The aforementioned intermediate transfer belt 24 is also in contact with the surface of the photoreceptor drum 30 via tonner. The intermediate transfer belt 24 is a member that causes wear on the photosensitive layer 31 by producing friction between the photoreceptor drum 30 and the intermediate transfer belt 24. The intermediate transfer belt 24 is another of wear means that cause wear on the surface of the photosensitive layer 31. In view of a rate of wear on the photosensitive layer 31, the cleaning blade 36 is the main wear mean and the intermediate transfer belt 24 is the secondary wear mean.

The brush 37 is arranged upstream of the cleaning blade 36 in a rotate direction R of the photoreceptor drum 30. The brush 37 rotates in a manner being in contact with the surface of the photoreceptor drum 30. The brush 37 is to level remaining toner attached to the surface of the photoreceptor drum 30 in upstream of the cleaning blade 36. A part of remaining toner is removed from the surface of the photoreceptor drum 30 also by the brush 37.

The flicker 38 rotates in a manner being in contact with the surface of the brush 37. The flicker 38 is to remove the remaining toner attached to the brush 37. The scraper 39 in contact with the flicker 38 scraps the remaining toner attached to the surface of the flicker 38.

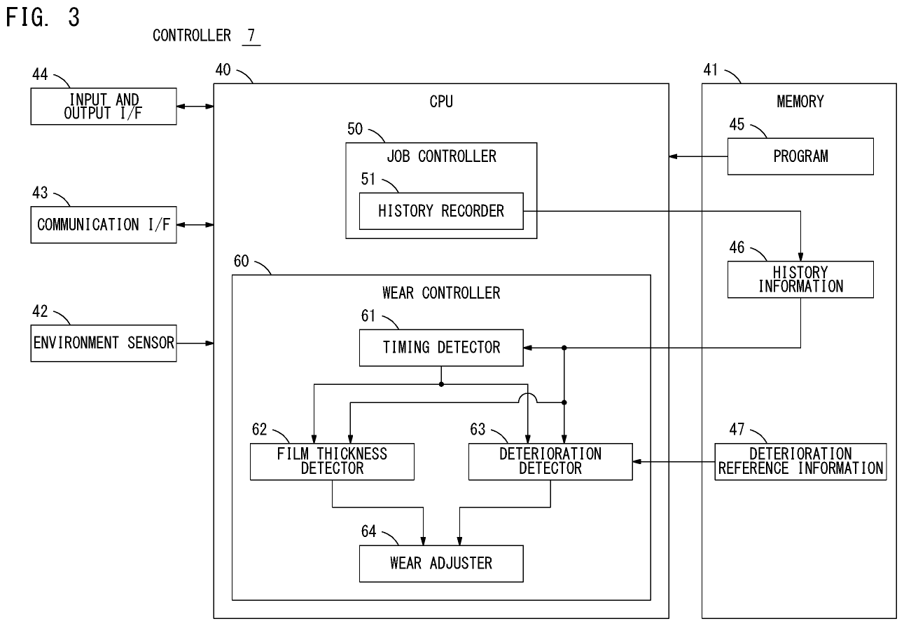

The controller 7 is explained next. FIG. 3 illustrates a block diagram showing an example of a hardware structure of the controller 7. The controller 7 includes a CPU 40, a memory 41, an environment sensor 42, a communication interface 43 and an input and output interface 44.

The CPU 40 is an arithmetic processor that reads and executes a program 45 stored in advance in the memory 41 to control operations of aforementioned each part. The CPU 40 executes the program 45 so that it serves as a job controller 50 and a wear controller 60. The detail of the job controller 50 and the wear controller 60 is explained later.

The memory 41 is a non-volatility memory rewritable by the CPU 40. The program 45 executed by the CPU 40 is stored in advance in the memory 41. History information 46 and deterioration reference information 47 is stored in the memory 41 besides the program 45. The history information 46 is updated every time the image is formed based on the print job in the image forming device 1. A history of processing the print job is stored as the history information 46. The deterioration reference information 47 is referred to detect a deterioration progress degree of the photosensitive layer 31. The detail of the history information 46 and the deterioration reference information 47 is explained later.

The environment sensor 42 obtains environment information when the print job is processed in the image forming device 1. The environment information obtained by the environment sensor 42 includes information such as temperature information, absolute humidity information, and atmospheric pressure information. To be more specific, the environment sensor 42 includes a temperature sensor, a humidity sensor and an atmospheric pressure sensor. The environment sensor 42 obtains the environment information from each of the sensors.

The communication interface 43 is to connect the image forming device 1 to a network such as LAN (Local Area Network) and enable communication with an external device over the network. The image forming device 1 receives the print job from the external device via the communication interface 43 and forms the image based on the received print job.

The input and output interface 44 is to input and output signals so that the CPU 40 may control the operations of the respective aforementioned paper feeding unit 2, image forming unit 3 and fixing unit 4. When the image is formed in the image forming device 1, the CPU 40 outputs a variety of control signals to the respective paper feeding unit 2, image forming unit 3 and fixing unit 4 via the input and output interface 44. The input and output interface 44 is enabled to provide the CPU 40 with the signals output from the respective paper feeding unit 2, image forming unit 3 and fixing unit 4, respectively.

The function of the CPU 40 is explained next. The job controller 50 controls processing of the print job in the image forming device 1. In response to receiving the print job via the communication interface 43, the job controller 50 drives each of the paper feeding unit 2, the image forming unit 3 and the fixing unit 4 based on the print job. To be more specific, the job controller 50 drives each part of the image forming unit 3 to transfer the toner image in each color, Y, M, C and K on the intermediate transfer belt 24 and form the color image. The job controller 50 feeds the recording material 9 one by one from the paper feeding unit 2 and supplies the recording material 9 toward the secondary transfer roller 25 at a timing the color image transferred to the intermediate transfer belt 24 reaches a nip position at the secondary transfer roller 25. After secondarily transferring the color image to the recording material 9, the job controller 50 enables the fixing unit 4 to fix the color image to the recording martial 9. The recording material 9 is then delivered on the paper delivery tray 6. Thus, the image corresponding to image data included in the print job is formed on the recording material 9 and the recording material 9 with the image is delivered on the paper delivery tray 6.

The job controller 50 includes a history recorder 51. The history recorder 51 is brought into operation when the print job is processed by the job controller 50. The history recorder 51 records a print job processing history as the history information 46. The history recorder 51 obtains the environment information including the temperature information, the absolute humidity information, and the atmospheric pressure information from the environment sensor 42 when the image is formed in the image forming device 1. The history recorder 51 also obtains a travel distance (number of rotations) traveled by the photoreceptor drum 30 in R direction in forming the image. Information such as the electrification voltage applied to the photoreceptor drum 30 in forming the image, a current value flew through the photoreceptor drum 30 for electrifying the photoreceptor drum 30, BW ratio (ratio of black and white) in forming the image and a torque for rotating and driving the photoreceptor drum 30 in R direction is further obtained by the history recorder 51. The history recorder 51 generates job history information containing each of the above-identified information. The history recorder 51 adds the generated job history information to the history information 46 in the memory 41 to update the history information 46.

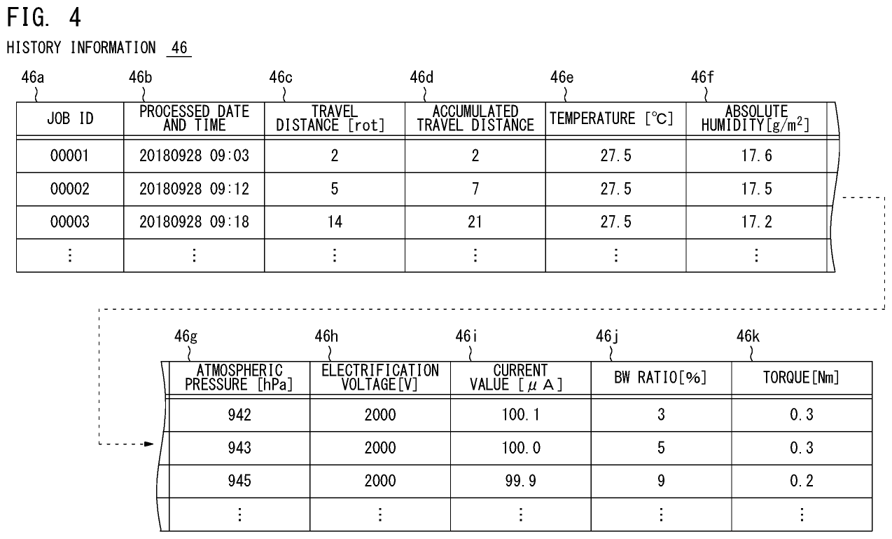

FIG. 4 illustrates an example of the history information 46. Information including a job ID 46a, the processed date and time 46b, a travel distance 46c, an accumulated travel distance 46d, a temperature 46e, an absolute humidity 46f, an atmospheric pressure 46g, an electrification voltage 46h, a current value 46i, a BW ratio 46j and a torque 46k is recorded as the history information 46 for each job. Any other information may be recorded as the history information 46.

The job ID 46a is unique identification information assigned for each job by the history recorder 51. The processed date and time 46b shows the date and time the print job is processed. The travel distance 46c shows a travel distance (the number of rotations) of the photoreceptor drum 30 that traveled during the processing of the print job. The travel distance calculated by the history recorder 51 is recorded as the accumulated travel distance 46d. The accumulated travel distance 46d is a value obtained by adding the travel distance of the photoreceptor drum 30 for processing the current print job to the accumulated travel distance calculated until the processing of the current print job. Once the photoreceptor drum 30 is replaced, for instance, the accumulated travel distance 46d is initialized to 0. The temperature measured by the environment sensor 42 at processing of the print job is recorded as the temperature 46e. The absolute humidity measured by the environment sensor 42 at processing of the print job is recorded as the absolute humidity 46f. This does not have to be the absolute humidity, but may be a relative humidity. The atmospheric pressure measured by the environment sensor 42 at processing of the print job is recorded as the atmospheric pressure 46g. The electrification voltage applied to the photoreceptor drum 30 at processing of the print job is recorded as the electrification voltage 46h. The current value flew through the photoreceptor drum 30 at processing of the print job is recorded as the current value 46i. The BW ratio 46j is a BW ratio (black and white ratio) showing a percentage of an area to which toner is attached at processing of the print job. The torque 46k shows a torque required for driving the photoreceptor drum 30 at processing of the print job.

This history information 46 is used to detect the deterioration progress degree of the photosensitive layer 31 of the photoreceptor drum 30 in the image forming device 1. Also, the history information 46 is used to detect wear progress degree (or a film thickness) of the photosensitive layer 31 of the photoreceptor drum 30 due to the wear means such as the cleaning blade 36 and/or the intermediate transfer belt 24.

The wear controller 60 detects the deterioration progress degree of the photosensitive layer 31 due to repeatedly performed electrification and discharge and the wear progress degree (or the film thickness) of the photosensitive layer 31 due to the wear mean such as the cleaning blade 36, and adjusts the wear progress degree in later process based on the detected deterioration progress degree and wear progress degree. The wear controller 60 of the present preferred embodiment adjusts a wear amount of wear on the photosensitive layer 31 due to the wear mean such as the cleaning blade 36 to adjust the wear progress degree of the photosensitive layer 31 in the later process. The wear controller 60 includes a timing detector 61, a film thickness detector 62, a deterioration detector 63 and a wear adjuster 64. Each of the above-described parts is explained in detail next.

The timing detector 61 detects whether or not it is time to adjust the wear progress degree. The timing detector 61 of the present preferred embodiment adjusts the wear amount of the photosensitive layer 31 due to the wear mean every time a predetermined period of time is elapsed. The timing detector 61 detects whether or not it is the time to adjust the wear amount after the elapse of the predetermined period of time. The more travel distance (the number of rotations) of the photoreceptor drum 30 progresses in the deterioration and wear on the surface of the photosensitive layer 31 of the photoreceptor drum 30. The timing detector 61 reads the history information 46 in the memory 41 and detects it is the time to adjust the wear progress degree every time the travel distance of the photoreceptor drum 30 reaches a predetermined travel distance. The timing detector 61, for instance, refers to the accumulated travel distance 46d of the history information 46. The timing detector 61 detects that it is time to adjust the wear progress degree every time the photoreceptor drum 30 rotates 10k (10000 rotations). After detecting it is time to adjust the wear progress degree, the timing detector 61 brings the film thickness detector 62 and the deterioration detector 63.

The film thickness detector 62 detects the film thickness of the photosensitive layer 31 of the present time. The thinner film thickness of the photosensitive layer 31, a lower resistance value of the photosensitive layer 31. The film thickness detector 62 detects the film thickness of the photosensitive layer 31 based on the resistance value. It is difficult to directly measure the resistance value of the photosensitive layer 31. The film thickness detector 62 detects the film thickness of the photosensitive layer 31 based on the current value of a time when the electrification voltage Vpp is applied for electrification of the surface of the photosensitive layer 31. More specifically, the film thickness detector 62 reads the history information 46 to refer the current value 46i, and detects the film thickness of the photosensitive layer 31 based on the current value of the time when the electrification voltage Vpp is applied in the current print job.

The resistance value of the photosensitive layer 31 may vary depend on the conditions such as temperature and/or humidity. The accurate film thickness of the photosensitive layer 31 may not be detected only based on the current value of the time when the electrification voltage Vpp is applied. In such a case, the film thickness detector 62 further reads the temperature 46e and the absolute humidity 46f measured during processing of the current print job, and detects the film thickness of the photosensitive layer 31 based on temperature, humidity and the current value.

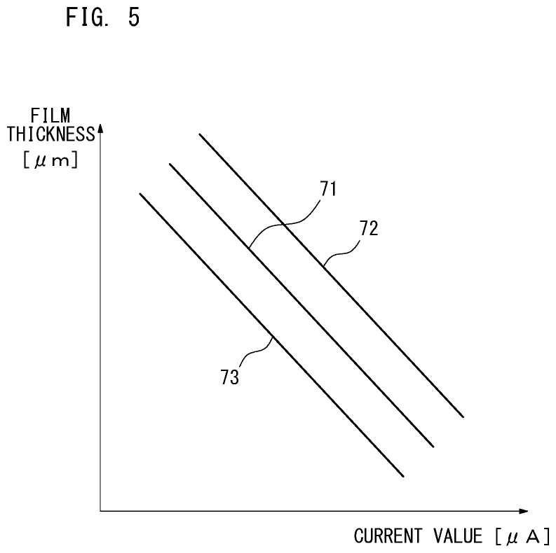

FIG. 5 illustrates a relation between the current value and the film thickness. In the example of FIG. 5, a characteristic line 71 indicates a relation between the current value and the film thickness when temperature and humidity are under a standard condition. A characteristic line 72 indicates a relation between the current value and the film thickness when temperature and humidity are high-temperature and high-humidity compared to the standard condition. A characteristic line 73 indicates a relation between the current value and the film thickness when temperature and humidity are low-temperature and low-humidity compared to the standard condition. The film thickness detector 62 selects one of the characteristic lines 71, 72 and 73 based on temperature and humidity read from the history information 46, and detects the film thickness of the photosensitive layer 31 based on the current value read from the history information 46. In the example of FIG. 5, three characteristic lines 71, 72 and 73 are shown. The conditions of temperature and/or humidity may be divided into smaller conditions and multiple characteristic lines indicating the smaller conditions may be set in advance. The more number of the characteristic lines can realize high accuracy detection of the film thickness of the photosensitive layer 31. After detecting the current film thickness of the photosensitive layer 31 as described above, the film thickness detector 62 outputs the detected film thickness to the wear adjuster 64.

The deterioration detector 63 detects the deterioration progress degree of the photosensitive layer 31 of the present time. The deterioration detector 63 detects the deterioration progress degree of the photosensitive layer 31 based on the history information 46 and the deterioration reference information 47.

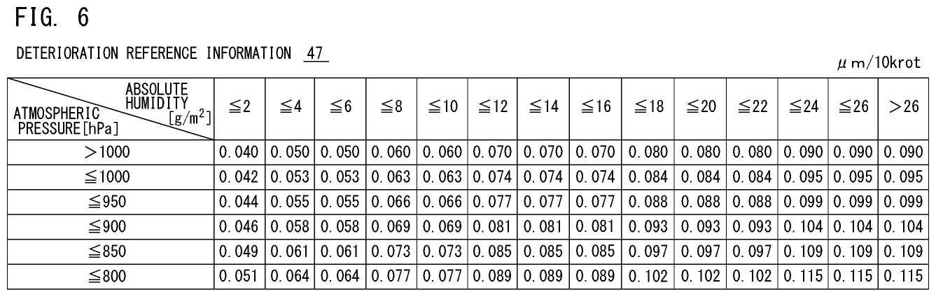

FIG. 6 illustrates an example of the deterioration reference information 47. The deterioration progress degree of the photosensitive layer 31 changes depending on the environment where the image forming device 1 is placed. Especially, humidity and atmospheric pressure affect the deterioration progress degree of the photosensitive layer 31 greatly. In the example of FIG. 6, the thickness of the deteriorated part of the photosensitive layer 31 at 10k rotations of the photoreceptor drum 30 is set, and the thickness (deterioration progress degree) is registered in advance corresponding to the absolute humidity and the atmospheric pressure. By referring to the deterioration reference information 47, the deterioration progress degree of the photosensitive layer 31 may be detected.

When it is time to adjust the wear progress degree, the deterioration detector 63 reads the history information 46 to calculate averages of absolute humidity and atmospheric pressure in a state that the photoreceptor drum 30 is driven. The averages of the absolute humidity and the atmospheric pressure measured from the previous adjustment time of the wear progress degree up to the current adjustment time are calculated. The number of the rotations of the photoreceptor drum 30 per the single print job may differ due to the number of the printings produced based on the print job. The deterioration detector 63 determines the percentage of absolute humidity and atmospheric pressure to the travel distance 46c based on the travel distance 46c in processing of each print job. The deterioration detector 63 then performs a weighting operation based on the determined percentage and calculates the averages of absolute humidity and atmospheric pressure measured from the previous time the number of rotations reaches 10K rotations up to the current time the number of rotations of the photoreceptor drum 30 reaches 10k rotations. The deterioration detector 63 refers to the deterioration reference information 47 based on the calculated average of absolute humidity and atmospheric pressure and detects the deterioration progress degree (film thickness of the deteriorated part) of the photosensitive layer 31 of the present time. As described above, upon detecting the deterioration progress degree of the photosensitive layer 31, the deterioration detector 63 outputs the detected deterioration progress degree to the wear adjuster 64.

Upon obtaining the deterioration progress degree from the deterioration detector 63, the wear adjuster 64 calculates the film thickness of the part which is not deteriorated of the photosensitive layer 31 based on the obtained deterioration progress degree. The wear adjuster 64 compares the film thickness of the part which is not deteriorated with the present film thickness of the photosensitive layer 31 obtained from the film thickness detector 62 to determine whether the deterioration progress degree matches with the wear progress degree. The difference between the deterioration progress degree and the wear progress degree is within a predetermined range, it may be determined that the deterioration progress degree and the wear progress degree match with each other.

Upon determining that the deterioration progress degree and the wear progress degree do not match with each other, the wear adjuster 64 adjusts the wear progress degree for the later process. The deterioration progress degree may be larger than the wear progress degree, for instance. In this case, the wear adjuster 64 adjusts to enable the deterioration progress degree to be larger in the later process. On the other hand, the wear progress degree may be larger than the deterioration progress degree, for instance. In this case, the wear adjuster 64 adjusts to enable the wear progress degree to be smaller in the later process.

The electrification voltage Vpp applied to the photoreceptor drum 30 may be varied to adjust the wear progress degree of the photosensitive layer 31 To be more specific, once the electrification voltage Vpp is varied, a charge quantity appeared on the surface of the photosensitive layer 31 changes so that the toner amount attached to the electrostatic latent image changes. The change in the toner amount causes a change in an amount of the remaining toner (abrasive) supplied to the cleaning blade 36. The amount removed by the cleaning blade 36 (wear amount) changes and the wear progress degree of the photosensitive layer 31 changes. The wear adjuster 64 of the present preferred embodiment adjusts the electrification voltage Vpp applied to the photoreceptor drum 30 so that it may adjust the wear progress degree of the photosensitive layer 31 in the later process.

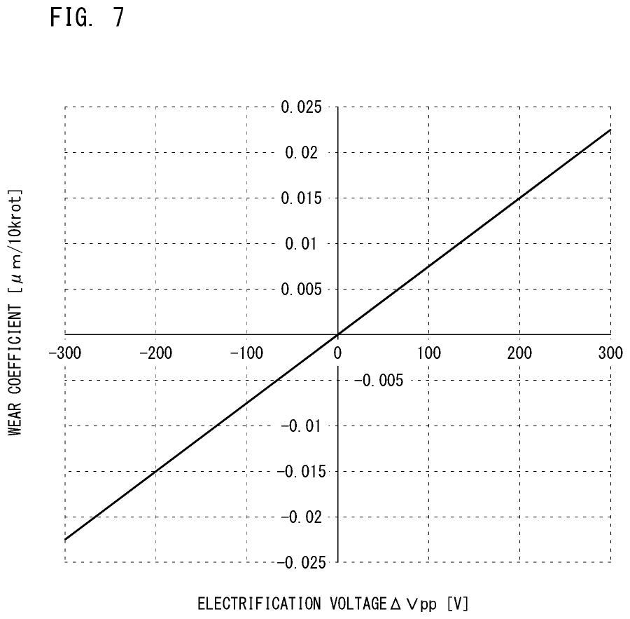

FIG. 7 illustrates an example of a relation between an adjustment amount of the electrification voltage Vpp and a coefficient of wear. The wear adjuster 64 adjusts the electrification voltage Vpp applied to the photoreceptor drum 30 based on the relation between the adjustment amount of the electrification voltage Vpp and the coefficient of wear of FIG. 7, and adjusts the wear progress degree for the later process.

It is assumed that the average absolute humidity, 17 g/m2 and the average atmospheric pressure, 930 hPa are calculated based on a period from the adjustment time for the previous wear adjustment degree up to the current adjustment time. In this case, the deterioration progress degree of the photosensitive layer 31 is 0.088 μm (see FIG. 6). If the wear progress degree is 0.078 μm, a deteriorated layer of 0.01 μm still remains on the surface of the photosensitive layer 31. In such a case, the wear adjuster 64 increases the electrification voltage Vpp by approximately 130V compared to the current value in order to increase the wear progress degree in the later process by approximately 0.01 μm. The wear adjuster 64 may increase the electrification voltage Vpp by approximately 200V in order to increase the wear progress degree in the later process by approximately 0.05 μm.

It is assumed that the deterioration progress degree is 0.088 μm, and the wear progress degree is 0.098 μm during the period from the previous adjustment time for wear adjustment degree up to the current adjustment time. In this case, the part not deteriorated of the photosensitive layer 31 is excessively removed 0.01 μm. In such a case, the wear adjuster 64 decreases the electrification voltage Vpp by approximately 130V compared to the current value in order to decrease the wear progress degree in the later process by approximately 0.01 μm. The wear adjuster 64 may decrease the electrification voltage Vpp by approximately 200V in order to decrease the wear progress degree in the later process by approximately 0.015 μm.

When the deterioration progress degree and the wear progress degree do not match, the wear adjuster 64 adjusts the wear progress degree for the later process so that it may control to enable the deterioration progress degree and the wear progress degree to be approximately equivalent to each other. The wear adjuster 64 controls the image quality deterioration due to deterioration of the photosensitive layer 31 and the shortened life of the photoreceptor drum 30 due to excess removing of the photosensitive layer 31.

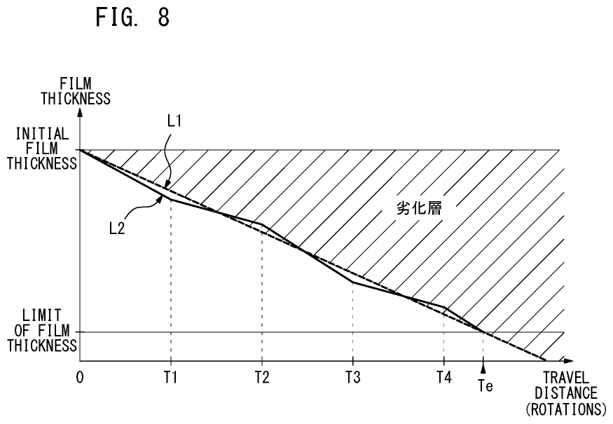

FIG. 8 illustrates an example of the adjustment of the deterioration progress degree and the wear progress degree by the wear controller 60. In the example of the adjustment of FIG. 8, the image forming device 1 is used under a certain environment. The film thickness of the photosensitive layer 31 is an initial film thickness which is unused. When the film thickness reaches a limit of the film thickness, it is an end of the life of the photosensitive layer 31 and time for the replacement. The deteriorated layer of the photosensitive layer 31 proceeds to a deeper layer from the surface in accordance with the increase in the travel distance (the number of rotations) of the photoreceptor drum 30. A broken line L1 of FIG. 8 indicates the deterioration progress degree of the photosensitive layer 31. If the image forming device 1 is used under a certain environment, the deterioration progress degree proceeds by a specified percentage to the travel distance of the photoreceptor drum 30. In contrast, a line L2 of FIG. 8 indicates the wear progress degree of the photosensitive layer 31. The wear progress degree may be adjusted by increasing or decreasing the toner amount to supply to the surface of the photoreceptor drum 30 as described above, for example. The wear controller 60 adjusts the wear progress degree to have the approximately same progress degree as the deterioration progress degree every time the number of rotations of the photoreceptor drum 30 reaches the predetermined number of rotations (timing T1, T2, T3 and T4). To be more specific, the inclination of the wear progress degree at each timing T1, T2, T3 and T4 may be larger than the inclination of the deterioration progress degree. In this case, the wear controller 60 adjusts to enable the inclination of the wear progress degree in the later process to be smaller. If, on the other hand, the inclination of the wear progress degree is smaller than the inclination of the deterioration progress degree, the wear controller 60 adjusts to enable the inclination of the wear progress degree in the later process to be larger. As a result, the wear degree of the photosensitive layer 31 and the deterioration degree of the photosensitive layer 31 roughly match with each other. Both of the image quality deterioration due to deterioration of the photosensitive layer 31 and the shortened life of the photoreceptor drum 30 due to excess removing of the photosensitive layer 31 may be effectively controlled. This control enable an extension of the life of the photoreceptor drum 30 to a maximum life (Te).

### (Another Way of Detecting the Film Thickness of the Photosensitive Layer 31)

Several ways to detect the film thickness of the photosensitive layer 31 are explained next.

The way that the film thickness detector 62 detects the film thickness of the photosensitive layer 31 based on the travel distance of the photoreceptor drum 30 and the BW ratio in forming an image is described first. When the travel distance of the photoreceptor drum 30 increases, the film thickness of the photosensitive layer 31 decreases in accordance with the increase in the travel distance. If the BW ratio in forming the image changes, the amount of the remaining toner supplied to the cleaning blade 36 changes in accordance with the change in the BW ratio. The wear progress degree of the photosensitive layer 31 then changes in accordance with the BW ratio. Based on this, the film thickness detector 62 is enabled to detect the film thickness of the photosensitive layer 31 based on the travel distance of the photoreceptor drum 30 and the BW ratio in forming of the image.

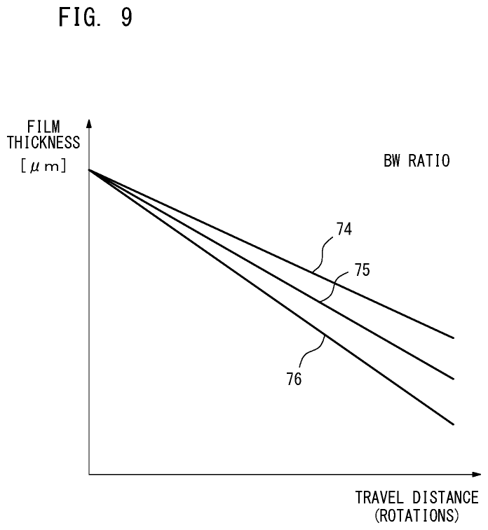

FIG. 9 illustrates an example of a relation between the travel distance of the photoreceptor drum 30 and the film thickness in accordance with the BW ratio. In the example of FIG. 9, a characteristic line 74 indicates a relation between the travel distance and the film thickness when the BW ratio is 1%. A characteristic line 75 indicates a relation between the travel distance and the film thickness when the BW ratio is 5%. A characteristic line 76 indicates a relation between the travel distance and the film thickness when the BW ratio is 10%. Increase in the BW ratio increases the remaining toner amount supplied to the cleaning blade 36 as described above. In contrast with the case where the BW ratio is small, the wear progress degree of the photosensitive layer 31 will be larger.

When it is time to detect the film thickness of the photosensitive layer 31 based on the travel distance, the film thickness detector 62 reads the history information 46 to calculate an average of the BW ratio during a period from the start of use of the photoreceptor drum 30 up to the current adjustment time. The number of the rotations of the photoreceptor drum 30 per the single print job may differ due to the number of the printings produced based on the print job. The film thickness detector 62 determines the percentage of the BW ratio to the travel distance 46c based on the travel distance 46c in processing of each print job. The film thickness detector 62 then performs a weighting operation based on the determined percentage and calculates the average of the BW ratio from the start of use of the photoreceptor drum 30 up to the current adjustment time. The film thickness detector 62 selects one of the characteristic lines 74, 75 and 76 based on the average BW ratio, and detects the film thickness of the photosensitive layer 31 based on the accumulated travel distance 46d read from the history information 46. In the example of FIG. 9, three characteristic lines 74, 75 and 76 are shown. The conditions of the BW ratio may be divided into smaller conditions and more than three characteristic lines may be set in advance. The more number of the characteristic lines realize high accuracy detection of the film thickness of the photosensitive layer 31. The film thickness detector 62 may detect the film thickness of the photosensitive layer 31 based on the travel distance of the photoreceptor drum 30 and the BW ratio in forming of the image as described above.

The way that the film thickness detector 62 detects the film thickness of the photosensitive layer 31 based on the travel distance of the photoreceptor drum 30 and the torque for driving the photoreceptor drum 30 is described next. When the travel distance of the photoreceptor drum 30 increases, the film thickness of the photosensitive layer 31 decreases in accordance with the increase in the travel distance. If a press pressure to the photoreceptor drum 30 by the cleaning blade 36 changes, the torque for rotating and driving the photoreceptor drum 30 changes in accordance with the change in the press pressure. The wear progress degree of the photosensitive layer 31, therefore, changes in accordance with the torque. Based on this, the film thickness detector 62 is enabled to detect the film thickness of the photosensitive layer 31 based on the travel distance of the photoreceptor drum 30 and the torque of the photoreceptor drum 30.

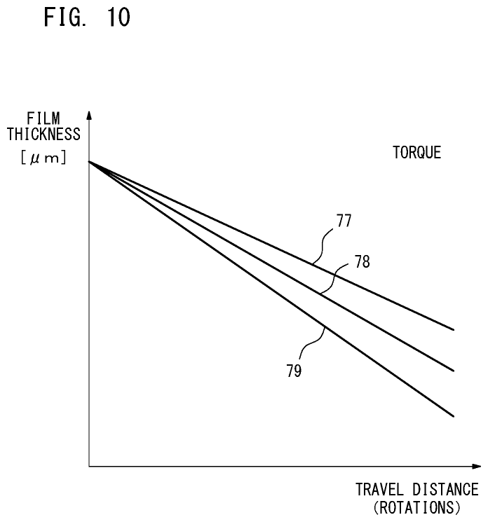

FIG. 10 illustrates an example of a relation between the travel distance of the photoreceptor drum 30 and the film thickness in accordance with the torque. In the example of FIG. 10, a characteristic line 77 indicates a relation between the travel distance and the film thickness when the torque is 0.1 Nm. A characteristic line 78 indicates a relation between the travel distance and the film thickness when the torque is 0.2 Nm. A characteristic line 79 indicates a relation between the travel distance and the film thickness when the torque is 0.3 Nm. Increase in the torque for driving the photoreceptor drum 30 increases the wear amount due to the cleaning blade 36 as described above. In contrast with the case where the torque is small, the wear progress degree of the photosensitive layer 31 will be larger.

For detecting the film thickness of the photosensitive layer 31 based on the travel distance, the film thickness detector 62 reads the history information 46 to calculate an average of the torque measured during a period from the start of use of the photoreceptor drum 30 up to the current adjustment time. The number of the rotations of the photoreceptor drum 30 per the single print job may differ due to the number of the printings produced based on the print job. The film thickness detector 62 determines the percentage of the torque to the travel distance 46c based on the travel distance 46c in processing of each print job. The film thickness detector 62 then performs a weighting operation based on the determined percentage and calculates the average of the torque measured from the start of use of the photoreceptor drum 30 up to the current adjustment time. The film thickness detector 62 selects one of the characteristic lines 77, 78 and 79 based on the average torque, and detects the film thickness of the photosensitive layer 31 based on the accumulated travel distance 46d read from the history information 46. In the example of FIG. 10, three characteristic lines 77, 78 and 79 are shown. The conditions of the torque may be divided into smaller conditions and more than three characteristic lines may be set in advance. The more number of the characteristic lines realize high accuracy detection of the film thickness of the photosensitive layer 31. The film thickness detector 62 may detect the film thickness of the photosensitive layer 31 based on the travel distance of the photoreceptor drum 30 and the torque for driving the photoreceptor drum 30 as described above.

### (Another Way of Adjusting the Wear Progress Degree)

Several ways for the wear adjuster 64 to adjust the wear progress degree of the photosensitive layer 31 are explained next.

The adjustment of the wear progress degree of the photosensitive layer 31 is enabled by making a difference in speed between the photoreceptor drum 30 and the brush 37. Normally, the brush 37 rotates at the same speed as the photoreceptor drum 30 so that it removes a certain amount of the remaining toner from the surface of the photoreceptor drum 30 in upstream of the cleaning blade 36, and levels the remaining toner supplied to the cleaning blade 36. When the rotation speed of the brush 37 is relatively higher than the rotation speed of the photoreceptor drum 30, the less amount of toner is removed by the brush 37 from the surface of the photoreceptor drum 30. In this case, the toner amount supplied to the cleaning blade 36 increases. On the other hand, when the rotation speed of the brush 37 is relatively lower than the rotation speed of the photoreceptor drum 30, the more amount of toner is removed by the brush 37 from the surface of the photoreceptor drum 30. In this case, the toner amount supplied to the cleaning blade 36 decreases. As described above, the wear adjuster 64 may adjust the wear progress degree of the photosensitive layer 31 for the later process by adjusting the difference in speed between the photoreceptor drum 30 and the brush 37.

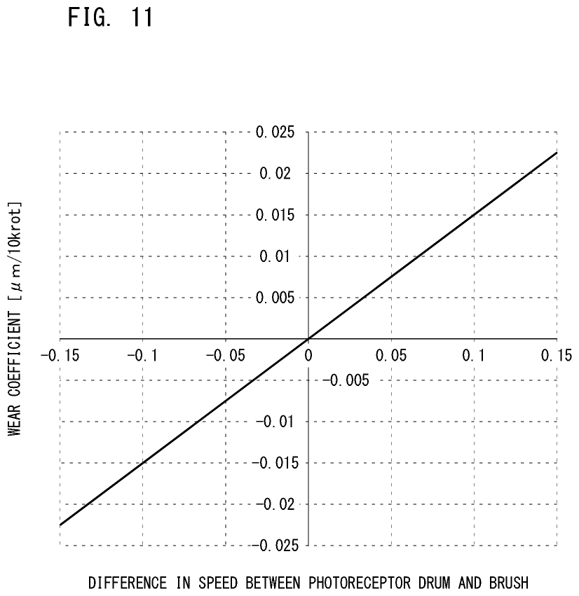

FIG. 11 illustrates a relation between the difference in speed between the photoreceptor drum 30 and the brush 37 and the wear coefficient. The wear adjuster 64 adjusts the rotation speed of the brush 37 based on the relation between the difference in speed and the wear coefficient as illustrated in FIG. 11 so that it may adjust the wear progress degree in the later process. It is assumed, for example, that the deterioration process degree of the photosensitive layer 31 is larger than the wear progress degree. In this case, the wear adjuster 64 adjusts to enable the rotation speed of the brush 37 to be higher than the rotation speed of the photoreceptor drum 30. The wear progress degree in the later process is then made larger, and the deterioration progress degree and the wear progress degree are roughly matched with each other. It is assumed, for example, that the deterioration process degree of the photosensitive layer 31 is smaller than the wear progress degree. In this case, the wear adjuster 64 adjusts to enable the rotation speed of the brush 37 to be lower than the rotation speed of the photoreceptor drum 30. The wear progress degree in the later process is then made smaller, and the deterioration progress degree and the wear progress degree are roughly matched with each other.

Moreover, the adjustment of the wear progress degree is enabled by having a difference in speed between the brush 37 and the flicker 38. Normally, the flicker 38 rotates at the same speed as the brush 37 so that it removes a certain amount of the remaining toner attached to the brush 37. When the rotation speed of the flicker 38 is relatively higher than the rotation speed of the brush 37, the less amount of toner is removed from the brush 37 by the flicker 38. In this case, the toner amount remaining on the brash 37 increases and the amount of toner attached again to the photoreceptor drum 30 from the brash 37 increases. On the other hand, when the rotation speed of the flicker 38 is relatively lower than the rotation speed of the brash 37, the more amount of toner is removed from the brush 37 by the flicker 38. In this case, the amount of toner attached again to the photoreceptor drum 30 decreases. As described above, the wear adjuster 64 may adjust the wear progress decree of the photosensitive layer 31 in the later process by adjusting the difference in speed between the brush 37 and the flicker 38.

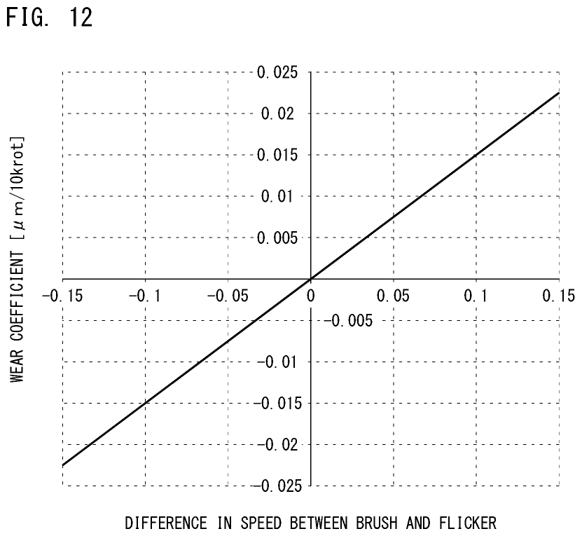

FIG. 12 illustrates a relation between the difference in speed between the brush 37 and the flicker 38 and the wear coefficient. The wear adjuster 64 adjusts the rotation speed of the flicker 38 based on the relation between the difference in speed and the wear coefficient as illustrated in FIG. 12 so that it may adjust the wear progress degree in the later process. It is assumed, for example, that the deterioration process degree of the photosensitive layer 31 is larger than the wear progress degree. In this case, the wear adjuster 64 adjusts to enable the rotation speed of the flicker 38 to be higher than the rotation speed of the brush 37. The wear progress degree in the later process is then made larger, and the deterioration progress degree and the wear progress degree are roughly matched with each other. It is assumed, for example, that the deterioration process degree of the photosensitive layer 31 is smaller than the wear progress degree. In this case, the wear adjuster 64 adjusts to enable the rotation speed of the flicker 38 to be lower than the rotation speed of the brush 37. The wear progress degree in the later process is then made smaller, and the deterioration progress degree and the wear progress degree are roughly matched with each other.

Furthermore, the wear adjuster 64 may adjust the wear progress degree by adjusting the press pressure by the cleaning blade 36 to the photoreceptor drum 30, for instance. Normally, the cleaning blade 36 is supported to be in contact with the surface of the photoreceptor drum 30 at a predetermined press pressure by the support member 36a. The press pressure to the photoreceptor drum 30 rises up to the high pressure, the wear amount of the photosensitive layer 31 increases. When the press pressure to the photoreceptor drum 30 is lowered, the wear amount of the photosensitive layer 31 decreases. As described above, the wear adjuster 64 may adjust the press pressure of the cleaning blade 36 due to the support member 36a.

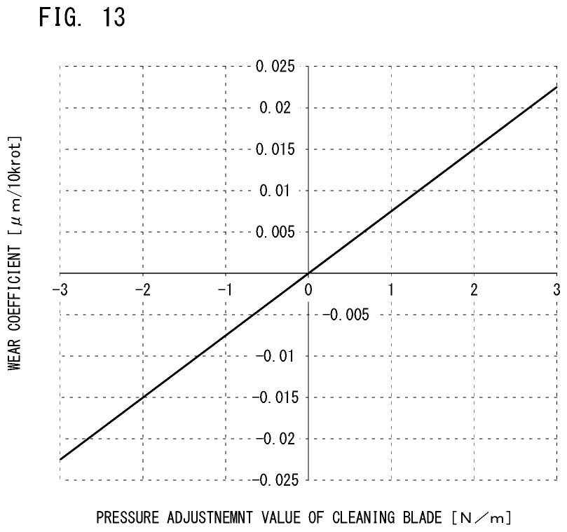

FIG. 13 illustrates a relation between the pressure adjustment value of the cleaning blade 36 and the wear coefficient. The wear adjuster 64 adjusts the support member 36a based on the relation between the pressure adjustment value and the wear coefficient as illustrated in FIG. 13 so that it may adjust the wear progress degree in the later process. It is assumed, for example, that the deterioration process degree of the photosensitive layer 31 is larger than the wear progress degree. In this case, the wear adjuster 64 adjusts to enable the press pressure due to the support member 36a to be high pressure. The wear progress degree in the later process is then made larger, and the deterioration progress degree and the wear progress degree are roughly matched with each other. It is assumed, for example, that the deterioration progress degree of the photosensitive layer 31 is smaller than the wear progress degree. In this case, the wear adjuster 64 adjusts to lower the press pressure due to the support member 36a. The wear progress degree in the later process is then made smaller, and the deterioration progress degree and the wear progress degree are roughly matched with each other.

Also, when the image data of multiple pages are included in the print job, for example, a toner patch may be formed on the surface of the photoreceptor drum 30 in an interval (paper gap) which is before forming the toner image of the following page on the photoreceptor drum 30 after forming the toner image of the previous page to transfer on the recording medium 9 on the photoreceptor drum 30. The adjustment of the wear amount due to the cleaning blade 36 may be enabled by adjusting the toner amount of the toner patch formed as described above. It is assumed that the toner patch is formed in the interval (paper gap). In this case, when the toner patch passes through the primary transfer position, the primary transfer voltage applied to the primary transfer roller 22 is turned off. The toner patch formed on the surface of the photoreceptor drum 30 is, therefore, not transferred to the intermediate transfer belt 24, and the toner patch remains on the surface of the photoreceptor drum 30 and is proceeded toward the cleaner 35. As described above, the wear adjuster 64 may adjust the wear progress degree of the photosensitive layer 31 in the later process by adjusting the toner amount of the toner patch and adjusting the toner amount supplied to the cleaning blade 36.

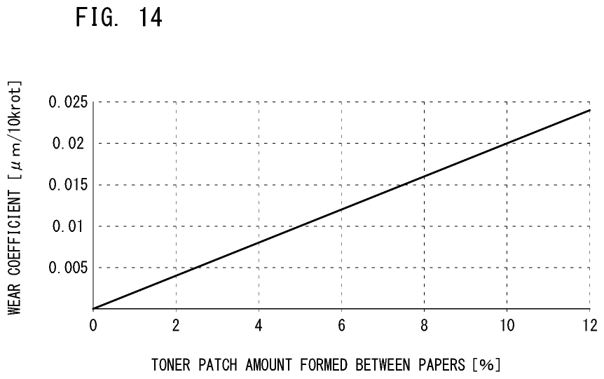

FIG. 14 illustrates a relation between the toner amount (a value equivalent to BW ratio) of the toner patch and the wear coefficient. The wear adjuster 64 adjusts the toner amount of the toner patch formed in the interval (paper gap) based on the relation between the toner amount of the toner patch and the wear coefficient as illustrated in FIG. 14 so that it may adjust the wear progress degree in the later process. It is assumed, for example, that the deterioration process degree of the photosensitive layer 31 is larger than the wear progress degree. In this case, the wear adjuster 64 adjusts to increase the toner amount of the toner patch. The wear progress degree in the later process is then made larger, and the deterioration progress degree and the wear progress degree are roughly matched with each other.

Additionally, the wear adjuster 64 adjusts the wear progress degree by changing the speed ratio of the intermediate transfer belt 24 and the photoreceptor drum 30. Normally, the intermediate transfer belt 24 circulates and moves at a speed the same as the rotation speed of the photoreceptor drum 30. If the speed of the circulation and move rises up to the higher speed than the rotation speed of the photoreceptor drum 30, the friction between the intermediate transfer belt 24 and the photoreceptor drum 30 will be large, and the wear progress degree of the photosensitive layer 31 will be larger. As described above, the wear adjuster 64 may adjust the wear progress degree of the photosensitive layer 31 by adjusting the speed ratio of the intermediate transfer belt 24 and the photoreceptor drum 30.

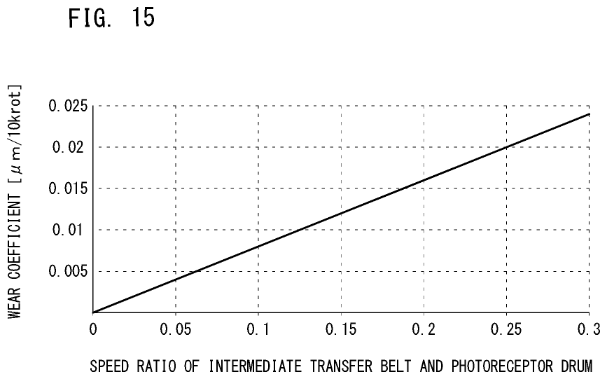

FIG. 15 illustrates a relation between the speed ratio of the intermediate transfer belt 24 and the photoreceptor drum 30 and the wear coefficient. The wear adjuster 64 changes the speed of the intermediate transfer belt 24 based on the relation between the speed ratio and the wear coefficient as illustrated in FIG. 15 so that it may adjust the wear progress degree in the later process. It is assumed, for example, that the deterioration process degree of the photosensitive layer 31 is larger than the wear progress degree. In this case, the wear adjuster 64 adjusts to increase the speed ratio. The wear progress degree in the later process is then made larger, and the deterioration progress degree and the wear progress degree are roughly matched with each other.

As described above, there are a variety of ways of adjusting the wear progress degree of the photosensitive layer 31. The wear adjuster 64 may adjust the wear progress degree using one or more than one of the above-described variety of ways.

### (Process Sequence Performed by the Controller 7)

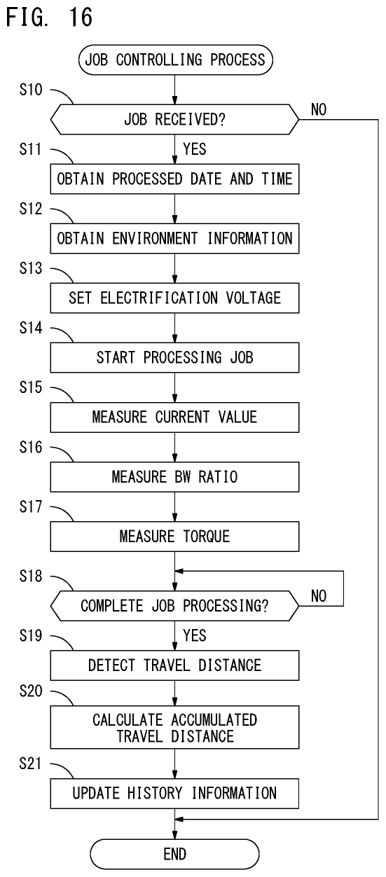

An exemplary procedure of a process performed by the controller 7 is explained next. FIG. 16 illustrates a flow diagram explaining an exemplary procedure of a job controlling process performed when the print job is processed in the image forming device 1. The job controlling process is repeatedly performed in a constant period by the controller 7 while the image forming device 1 is powered.

Upon start of the process, the controller 7 determines if the print job is received (step S10). When the print job is not received (when a result of step S10 is NO), the job controlling process is complete. In response to receiving the print job (when a result of step S10 is YES), the controller 7 obtains the processed date and time (step S11), and further obtains the environment information form the environment sensor 42 (step S12). The controller 7 then sets the electrification voltage Vpp (step S13). If the electrification voltage Vpp has already been adjusted through the wear controlling process described later, the controller 7 sets the adjusted electrification voltage Vpp. The controller 7 then starts processing the print job (step S14). In response to the start of processing of the print job, the paper feeding unit 2, the image forming unit 3 and the fixing unit 4 are driven to start forming the image on the recording material 9.

After starting processing of the print job, the controller 7 measures the current value of the photoreceptor drum 30, the BW ratio and the torque of the photoreceptor drum 30 one after another (steps S15, S16 and S17). The controller 7 waits until completion of processing of the print job (step S18). When processing of the print job completes (when a result of step S18 is YES), the controller 7 detects the travel distance (the number of rotations) of the photoreceptor drum 30 during processing of the print job (step S19). The controller 7 also calculates the accumulated travel distance (step S20). The controller 7 then updates the history information 46 and completes the job controlling process.

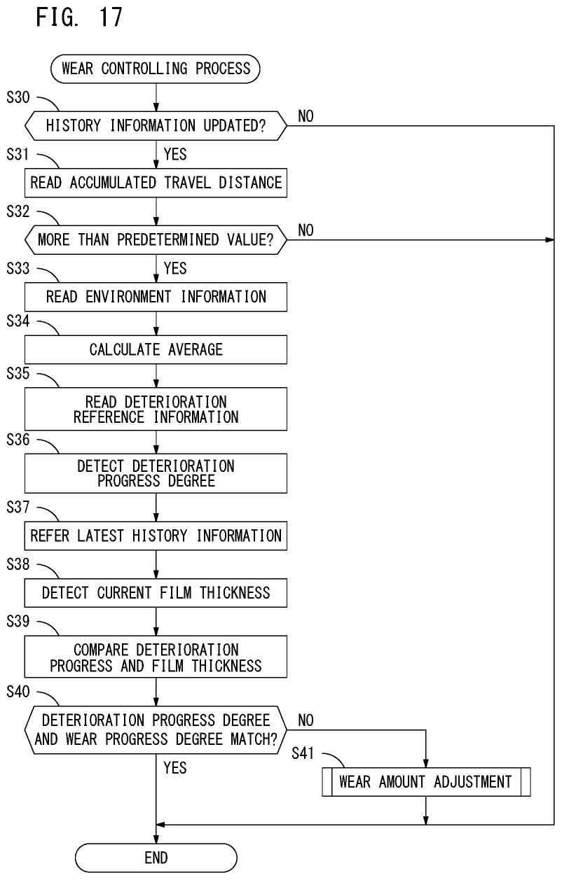

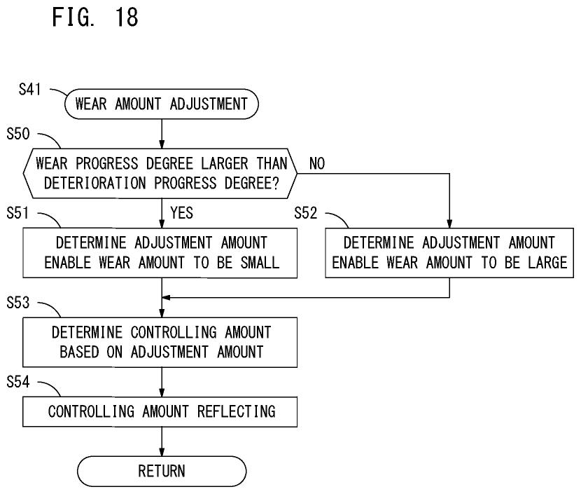

FIGS. 17 and 18 illustrate flow diagrams explaining an exemplary procedure of a wear controlling process performed to adjust the wear progress degree in the image forming device 1. The wear controlling process is repeatedly performed in a constant period by the controller 7 while the image forming device 1 is powered, as well as the job controlling process.

Upon starting the wear controlling process, the controller 7 determines if the history information 46 is updated (step S30). When the history information 46 is not updated (when a result of step S30 is NO), the wear controlling process is complete. When the history information 46 is updated (when a result of step S30 is YES), the controller 7 reads the accumulated travel distance 46d in the history information 46 (step S31), and determines whether or not the accumulated travel distance 46d is equal to or more than a predetermined value (step S32). To be more specific, the controller 7 determines if it is time to adjust the wear progress degree in step S32. The accumulated travel distance 46d may be less than the predetermined value (when a result of step S32 is NO). In this case, the wear controlling process completes. On the other hand, the accumulated travel distance 46d may be equal to or more than the predetermined value (when a result of step S32 is YES). In such a case, the controller 7 moves on to the process to adjust the wear progress degree.

In order to adjust the wear progress degree, the controller 7 reads the environment information (temperature 46e, absolute humidity 46f and atmospheric pressure 46g) (step S33), and calculates the average of the absolute humidity and the average of the atmospheric pressure while the photoreceptor drum 30 is driven during the period between the previous adjustment time of the wear progress degree and the current adjustment time (step S34). The controller 7 reads the deterioration reference information 47 (step S35), and detects the deterioration progress degree of the photosensitive layer 31 based on the respective averages of the absolute humidity and the atmospheric pressure and the deterioration reference information 47 (step S36).

The controller 7 then refers to the history information 46 of the latest print job (step S37), and detects the film thickness of the current photosensitive layer 31 based on the information such as the current value 46i (step S38).

The controller 7 compares the deterioration progress degree and the film thickness of the photosensitive layer 31 with each other (step S39), and determines if the deterioration progress degree matches with the wear progress degree (step S40). The deterioration progress degree and the wear progress degree may match with each other (when a result of step S40 is YES). In this case, it is not necessary to adjust the wear progress degree, and the wear controlling process completes. When the deterioration progress degree and the wear progress degree do not match with each other (when a result of step S40 is NO), the controller 7 starts a wear amount adjustment.

FIG. 18 illustrates a flow diagram explaining an exemplary procedure of the wear amount adjustment (step S41) in detail. Upon starting the wear amount adjustment, the controller 7 determines whether or not the wear progress degree is larger than the deterioration progress degree (step S50). When the wear progress degree is larger than the deterioration progress degree (when a result of step S50 is YES), the controller 7 determines the adjustment amount that enables the wear amount due to the wear means such as the cleaning blade 36 to be small (step S51). The deterioration progress degree may be larger than the wear progress degree (when a result of step S50 is NO). In this case, the controller 7 determines the adjustment amount that enables the wear amount due to the wear means such as the cleaning blade 36 to be large (step S52).

The controller 7 then determines a controlling amount based on the adjustment amount determined in step S51 or S52 (step S53). In order to adjust the electrification voltage Vpp, for instance, the controlling amount of the electrification voltage Vpp is determined based on the relation illustrated in FIG. 7. The controller 7 performs a process to reflect the controlling amount (step S54). To be more specific, the controller 7 reflects the controlling amount to enable that the later print job is processed under the condition that the controlling amount is reflected when the print job is processed thereafter. Thus, the wear amount adjustment is complete.

In the above-described flow diagram, the controller 7 detects itself the deterioration progress degree and the wear progress degree. However, this is given not for limitation. The controller 7, for example, may communicate with a server on a network or cloud and enable the server to detect the deterioration progress degree and the wear progress degree of the photosensitive layer 31. More specifically, the controller 7 may send the information included in the history information 46 and obtain the deterioration progress degree and the wear progress degree from the server.

The controller 7 may also use the server for determining the adjustment amount for adjusting the wear amount. To be more specific, the controller 7 may send the deterioration progress degree and the wear progress degree to the server and obtain the adjustment amount of the wear progress degree from the server. The above-mentioned server may be installed on cloud, for example. The server on cloud then may remotely control the wear progress degree of the image forming device 1 installed all over the world.

As described above, the image forming device 1 of the present preferred embodiment includes the film thickness detector 62, the deterioration detector 63 and the wear adjuster 64. The film thickness detector 62 detects the film thickness of the photosensitive layer 31, and the deterioration detector 63 detects the deterioration progress degree of the photosensitive layer 31. The wear adjuster 64 compares the film thickness and the deterioration progress degree of the photosensitive layer 31 with each other and adjusts the wear amount of the photosensitive layer 31. With this structure, the image forming device 1 enables the deteriorated part on the top surface of the photosensitive layer 31 to be worn due to the wear means such as the cleaning blade 36. Moreover, the image forming device 1 enables to match the deterioration progress degree and the wear progress degree with each other. The image forming device 1 of the present preferred embodiment, therefore, is enabled to control the image quality deterioration due to the deterioration of the photosensitive layer 31 and extends the life of the photosensitive layer 31 to the maximum.

As described above, the wear amount of the image carrier is adjusted so that the deterioration progress degree and the wear progress degree may be roughly matched with each other. This controls the deterioration of the image quality due to the deterioration of the image carrier and extends the life of the image carrier to the maximum.

Although the embodiments of the present invention have been described and illustrated in detail, it is clearly understood that the same is by way of illustration and example only and not limitation, the scope of the present invention should be interpreted by terms of the appended claims

### (Modifications)

While the preferred embodiment of the present invention has been described above, the present invention is not limited to the preferred embodiment. Various modifications may be applied to the present invention.

In the above-described preferred embodiment, for example, the image forming device 1 is constructed by a printer. However, this is given not for limitation. The image forming device 1 may be constructed by a device such as one of MFPs (Multifunction Peripherals) including multiple functions, and a printer function may be included as one of the multiple functions.

In the above-described preferred embodiment, the wear progress degree of the photosensitive layer 31 is adjusted by mainly focusing on the single image forming unit 21. However, this is given not for limitation To be more specific, the operation to adjust the wear progress degree as described above is applicable to the respective image forming units 21Y, 21M, 21C and 21K of each color Y, M, C and K. When applying the aforementioned operation to each of the image forming units 21Y, 21M, 21C and 21K, the information of each image forming unit 21Y, 21M, 21C and 21K should be separately recorded. For adjusting the wear progress degree in each of the image forming units 21Y, 21M, 21C and 21K, the information of each unit should be referred.

The program 45 of the present preferred embodiment is installed in advance in the image forming device 1. The program 45 does not always have to be installed in advance in the image forming device 1. The program 45 may be the target of trading independently. The program 45 then may be provided with the image forming device 1 over a network, or may be provided with the image forming device 1 in a manner that is recorded on a computer readable recording medium such as a CD-ROM.

What is claimed is:

1. An image forming device provided with a wear part arranged in a manner being in contact with a surface of an image carrier to wear the surface of the image carrier, comprises:
a hardware processor that:
detects a film thickness of the image carrier;
detects a deterioration progress degree of the image carrier; and
compares the detected film thickness with the detected deterioration progress degree, and adjusts a wear amount of wear due to the wear mean based on the comparison result.

2. The image forming device according to claim 1, wherein the hardware processor further:
changes, upon determining the surface of the image carrier is deteriorated as a result of the comparison of the film thickness and the deterioration progress degree of the image carrier, a setting to enable the wear amount due to the wear part to be large, wherein
upon determining the surface of the image carrier is not deteriorated, the hardware processor changes the setting to enable the wear amount due to the wear part to be small.

3. The image forming device according to claim 1, wherein the hardware processor further:
detects the film thickness of the image carrier every time a predetermined period is elapsed;
detects the deterioration progress degree of the image carrier every time the predetermined period is elapsed; and
adjusts the wear amount due to the wear part based on the film thickness and the deterioration progress degree detected every time the predetermined period is elapsed.

4. The image forming device according to claim 3, wherein
the predetermined period is a period required for a travel distance of the image carrier to reach a predetermined distance.

5. The image forming device according to claim 3, further comprising:
an environment sensor that obtains environment information including information regarding humidity and atmospheric pressure, wherein
the hardware processor detects the deterioration progress degree of the image carrier based on respective averages of humidity and atmospheric pressure obtained by the environment sensor during the predetermined period.

6. The image forming device according to claim 1, wherein the hardware processor further:
detects the film thickness of the image carrier based on a resistance value of the image carrier.

7. The image forming device according to claim 1, wherein the hardware processor further:
detects the film thickness of the image carrier based on a current value of a time when an electrification voltage is applied to the image carrier.

8. The image forming device according to claim 1, wherein the hardware processor further:
detects the film thickness of the image carrier based on an accumulated travel distance of the image carrier.

9. The image forming device according to claim 8, wherein the hardware processor further:
detects the film thickness of the image carrier based on a BW ratio in forming images.

10. The image forming device according to claim 8, wherein the hardware processor further:
detects the film thickness of the image carrier based on a torque for driving the image carrier.

11. The image forming device according to claim 1, wherein the hardware processor further:
adjusts the electrification voltage to apply to the image carrier to adjust the wear amount due to the wear part.

12. The image forming device according to claim 1, wherein
the wear part comprises a cleaning part arranged in a manner being in contact with the surface of the image carrier, and
the hardware processor adjusts a press pressure by the cleaning part to adjust the wear amount due to the wear part.

13. The image forming device according to claim 1, wherein
the wear part comprises:
the cleaning part arranged in a manner being in contact with the surface of the image carrier;
a brush that rotates upstream of the cleaning part in a manner being in contact with the surface of the image carrier; and
a flicker that rotates in a manner being in contact with the brush, and
the hardware processor adjusts the number of the rotations of the brush or the number of rotations of the flicker to adjust the wear amount due to the wear part.

14. The image forming device according to claim 1, wherein
the wear part comprises the cleaning part arranged in a manner being in contact with the surface of the image carrier, and
the hardware processor further:
forms a toner patch on the image carrier after a first toner image transferred to a recording material is formed on the image carrier before a second toner image is formed on the image carrier; and
adjusts a toner amount of the toner patch to adjust the wear amount due to the cleaning part.

15. The image forming device according to claim 1, wherein
the wear part comprises an intermediate transfer body that moves in a manner being in contact with the surface of the image carrier, and
the hardware processor adjusts a moving speed of the intermediate transfer body to adjust the wear amount due to the wear part.

16. An image forming method applied to an image forming device that comprises a wear part arranged in a manner being in contact with a surface of an image carrier to wear the surface of the image carrier, the image forming method comprising:
detecting a film thickness of the image carrier;
detecting a deterioration progress degree of the image carrier;
determining an adjustment amount of a wear amount of wear due to the wear part using the detected film thickness and the detected deterioration progress degree; and
adjusting the wear amount of wear due to the wear part based on a result of the determination.

17. A non-transitory recording medium storing a computer readable program to be executed by a hardware processor in an image forming device comprises a wear part arranged in a manner being in contact with a surface of an image carrier to wear the surface of the image carrier, the hardware processor executing the computer readable program to perform:
detecting a film thickness of the image carrier;
detecting a deterioration progress degree of the image carrier;
determining an adjustment amount of a wear amount of wear due to the wear part using the detected film thickness and the detected deterioration progress degree; and
adjusting the wear amount of wear due to the wear part based on a result of the determination.
